(19) United States
(12) Patent Application Publication
(10) Pub. No.: US 2022/0201011 A1
(43) Pub. Date: Jun. 23, 2022

(54) METHOD AND APPARATUS FOR CLASSIFYING EXPLOIT ATTACK TYPE

(71) Applicant: KOREA INTERNET & SECURITY AGENCY, Jeollanam-do (KR)

(72) Inventors: Jae Hyuk Lee, Jeollanam-do (KR); Woong Go, Jeollanam-do (KR); Hong Geun Kim, Jeollanam-do (KR); Sung Taek Oh, Jeollanam-do (KR)

(73) Assignee: KOREA INTERNET & SECURITY AGENCY, Jeollanam-do (KR)

(21) Appl. No.: 17/216,328

(22) Filed: Mar. 29, 2021

(30) Foreign Application Priority Data
Dec. 21, 2020 (KR) 10-2020-0179466

(51) Int. Cl. H04L 29/06; G06F 16/28; G06F 16/951

(52) U.S. Cl. CPC H04L 63/1416; G06F 16/285; G06F 16/951; H04L 63/20; H04L 63/1433

(57) ABSTRACT

Provided is a method performed by a computing device for classifying a type of exploit. The method comprises extracting one or more keywords included in first information of a target exploit, classifying the target exploit as a first type attack corresponding to one of the one or more keywords based on vulnerability information of a target device obtained from a vulnerability collection channel, classifying the target exploit as a second type attack, the second type attack being a subtype of the classified first type attack based on the one of the one or more keywords and generating a detection rule for detecting the target exploit associated with the first information of the target exploit based on the classified second type attack

This patent application claims the benefit of Korean Patent Application No. 10-2020-0179466, filed on Dec. 21, 2020, which is hereby incorporated by reference in its entirety into this application.

### FIELD

The present disclosure relates to a method and an apparatus for classifying an exploit attack type for improving detection accuracy for an exploit attack. More specifically, it relates to a method and an apparatus for automatically classifying an exploit attack type based on a keyword extracted from exploit information.

### DESCRIPTION OF THE RELATED ART

An exploit attack refers to a procedure or set of commands, scripts, programs, specific pieces of data, or an attack that use them to perform the intended actions of an attacker by using design flaws such as computer software or hardware bugs, security vulnerabilities, etc. Since an exploit attack is an attack using bugs or vulnerabilities of software or hardware, etc. it is performed on a relatively large scale, and has a characteristic that indiscriminately attack not only a specific target but also an unspecified number of people, causing enormous economic damage. Therefore, it is very important to accurately detect an exploit attack, and improving the detection performance of an exploit attack is also one of the important topics in the field of information security.

Most attack detection systems (or intrusion detection systems) proposed so far detect exploit attacks based on predefined detection rules. More specifically, when a system administrator, who is an information security expert, manually defines and sets a detection rule, attack detection is performed according to the set detection rule. Further, system performance (or security of the domain, to which the attack detection system is applied) is maintained by periodically updating detection rules by the system administrator.

However, in the above method, system performance cannot be objectively guaranteed because the detection rule setting and optimization are too dependent on the administrator's experience. Further, since detection rule setting and optimization are performed manually by the administrator, considerable human cost and time cost are inevitably put in place. In addition, if the administrator's experience is insufficient, detection rule updates are not performed in a timely manner or detection rules are not optimized well, resulting in poor detection performance (e.g. accuracy) and detection speed for exploit attacks.

Therefore, there is a need for an automated detection rule setting method to accurately detect an exploit attack. As a prerequisite for solving this need, a method of automating the classification of exploit attacks is also required.

### SUMMARY

A technical problem to be solved through some embodiments of the present disclosure is to provide an apparatus for automatically classifying exploit attack types and a method performed in the apparatus.

Another technical problem to be solved through some embodiments of the present disclosure is to provide an apparatus for automatically setting a detection rule to improve detection accuracy for an exploit attack and a method performed in the apparatus.

Another technical problem to be solved through some embodiments of the present disclosure is to provide an apparatus for updating the rules in an automated manner so that the detection performance of the detection rule-based attack detection system can be objectively guaranteed by using the classification result of the exploit attack and a method performed in the apparatus.

The technical problems of the present disclosure are not limited to the technical problems mentioned above, and other technical problems that are not mentioned will be clearly understood by those skilled in the art from the following description.

According to a method performed by a computing device for classifying a type of exploit comprising extracting one or more keywords included in first information of a target exploit, classifying the target exploit as a first type attack corresponding to one of the one or more keywords based on vulnerability information of a target device obtained from a vulnerability collection channel, classifying the target exploit as a second type attack, the second type attack being a subtype of the classified first type attack based on the one of the one or more keywords and generating a detection rule for detecting the target exploit associated with the first information of the target exploit based on the classified second type attack.

According to an embodiment, wherein the first information of the target exploit comprises an exploit code, wherein extracting the one of the one or more keywords comprises extracting the one of the one or more keywords based on a payload portion within the exploit code.

According to an embodiment, wherein the first information of the target exploit includes second information collected through web crawling from one or more exploit collection channels, wherein the vulnerability information is cross-related with the first information of the target exploit and includes third information collected through web crawling from one or more vulnerability collection channels.

According to an embodiment further comprises updating at least some of a plurality of detection rules based on a classification result of a plurality of exploits.

According to an embodiment, further comprises wherein the updating comprises calculating an increasing or decreasing trend of the number of the classified second type attack and raising a strength of a response to the second type attack whose number has an increasing trend based on the calculation.

According to an embodiment, wherein the updating comprises calculating an increasing or decreasing trend of the number of the classified second type attack and raising a priority of a detection rule corresponding to the second type attack whose number has an increasing trend based on the calculation.

According to an embodiment, wherein the updating comprises calculating an increasing or decreasing trend of the number of the classified second type attack and lowering a strength of a response to the second type attack whose number has a decreasing trend based on the calculation.

According to an embodiment, wherein the updating comprises calculating an increasing or decreasing trend of the number of the classified second type attack and deleting a detection rule corresponding to the second type attack whose number has a decreasing trend based on the calculation, or designating the detection rule as a modification target.

According to an embodiment, wherein the first type attack includes a Denial of Service (DoS) attack, wherein the second type attack includes one or more of a Buffer Overflow attack, Crafted GET Request attack, Crafted POST Request attack, ICMP Flooding attack, SYN Flooding attack and Invalid URL Path attack.

According to an embodiment, wherein the first type attack includes one or more of a SQL injection attack, wherein the second type attack includes one or more of a Union-based SQL Injection attack, Blind-based SQL Injection attack, Time-based SQL Injection attack, and Error-based SQL Injection attack.

According to another aspect of the present disclosure, there is provided an apparatus for classifying a type of exploit comprising, a processor, a network interface, a memory and a computer program loaded into the memory and executed by the processor, wherein the computer program comprises a first instruction for extracting one or more keywords included in first information of a target exploit, a second instruction for classifying the target exploit as a first type attack corresponding to one of the one or more keywords based on vulnerability information of a target device obtained from a vulnerability collection channel, a third instruction for classifying the target exploit as a second type attack, the second type attack being a subtype of the classified first type attack based on the one of the one or more keywords and a fourth instruction for generating a detection rule for detecting the target exploit associated with the first information of the target exploit based on the classified second type attack.

According to another aspect of the present disclosure, there is provided a computer-readable recording medium recording a computer program including computer program instructions executable by a processor for classifying a type of exploit, wherein the computer program instructions are executed by a processor of a computing device for performing operations comprising, extracting one or more keywords included in first information of a target exploit, classifying the target exploit as a first type attack corresponding to one of the one or more keywords based on vulnerability information of a target device obtained from a vulnerability collection channel, classifying the target exploit as a second type attack, the second type attack being a subtype of the classified first type attack based on the one of the one or more keywords and generating a detection rule for detecting the target exploit associated with the first information of the target exploit based on the classified second type attack.

### BRIEF DESCRIPTION OF THE DRAWINGS

FIG. 1 illustrates an exemplary environment, in which an exploit attack type classification apparatus according to an embodiment of the present disclosure can be applied.

FIGS. 2 to 4 are exemplary block diagrams for describing an exploit attack type classification apparatus according to an embodiment of the present disclosure.

FIG. 5 is an exemplary block diagram illustrating an attack detection system that may be referred to in some embodiments of the present disclosure.

FIG. 6 is an exemplary flowchart illustrating a method of classifying an exploit attack type according to another embodiment of the present disclosure.

FIG. 7 is an exemplary diagram for further describing an operation of collecting various information that can be referred to in the method for classifying an exploit attack type described with reference to FIG. 6.

FIG. 8 is a diagram illustrating an exemplary process, in which information is collected and processed by the collection operation described with reference to FIG. 7.

FIGS. 9 and 10 illustrate types and examples of collected information that can be referenced in some embodiments of the present disclosure.

FIGS. 11 to 13 illustrate formats and examples of detection rules that can be referenced in some embodiments of the present disclosure.

FIG. 14 illustrates an example of a first attack type and a second attack type that may be referred to in some embodiments of the present disclosure.

FIG. 15 is an exemplary hardware configuration diagram that can implement an apparatus according to an embodiment of the present disclosure.

### DETAILED DESCRIPTION

Hereinafter, embodiments of the present disclosure will be described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments may be provided so that this disclosure will be thorough and complete and will fully convey the concept of the disclosure to those skilled in the art, and the present disclosure will be defined by the appended claims.

In adding reference numerals to the components of each drawing, it should be noted that the same reference numerals may be assigned to the same components as much as possible even though they may be shown in different drawings. In addition, in describing the present disclosure, based on it being determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing embodiments and is not intended to be limiting of the present disclosure. In this specification, the singular also includes the plural unless specifically stated otherwise in the phrase.

In addition, in describing the component of this present disclosure, terms, such as first, second, A, B, (a), (b), can be used. These terms may be for distinguishing the components from other components, and the nature or order of the components is not limited by the terms. Based on a component being described as being “connected,” “coupled” or “contacted” to another component, that component may be directly connected to or contacted with that other component, but it should be understood that another component also may be “connected,” “coupled” or “contacted” between each component.

Hereinafter, some embodiments of the present disclosure will be described in detail with reference to the accompanying drawings.

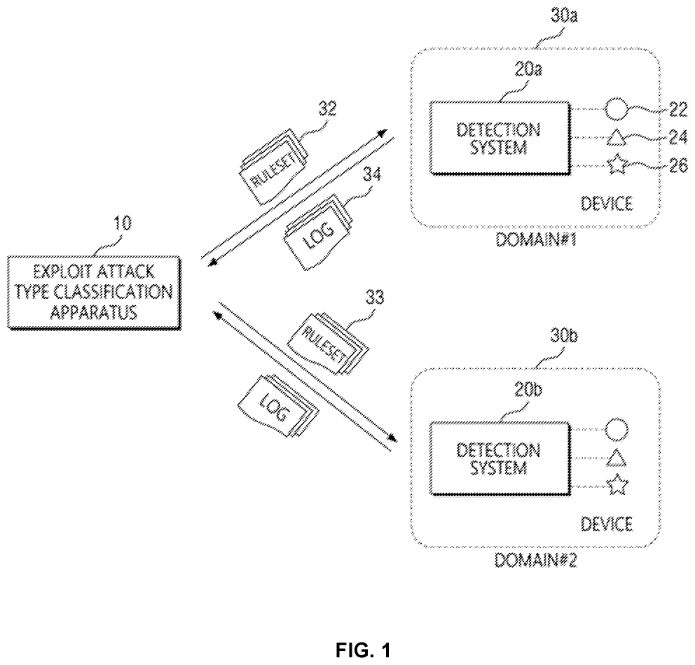

FIG. 1 illustrates an exemplary environment, in which an exploit attack type classification apparatus 10 according to an embodiment of the present disclosure may be applied. FIG. 1 illustrates that the exploit attack type classification apparatus 10 may be applied to two domains 30a and 30b, but this is for convenience of understanding, and the number of domains may vary.

As shown in FIG. 1, the exploit attack type classification apparatus 10 may be applied to one or more domains 30a and 30b to generate a detection rule for detecting an exploit attack.

Further, the exploit attack type classification apparatus 10 provides rulesets 32 and 33, which may be a set of generated rules, to the attack detection systems 20a and 20b, and receives log data 34 including the attack detection results. In some embodiments of the present disclosure related to this, the exploit attack type classification apparatus 10 may update at least some of a plurality of detection rules using the log data 34 received from the attack detection systems 20a and 20b. However, since the above-described operation may be an additional operation that can be performed by an embodiment of the present disclosure, detailed descriptions related to the above will be omitted in order not to obscure the subject matter of the present disclosure.

Further, the exploit attack type classification apparatus 10 may classify an attack type corresponding to the exploit information based on the exploit information collected from an external channel in an operation of generating a detection rule. In this case, the exploit attack type classification apparatus 10 may generate a detection rule for detecting an exploit attack associated with the exploit information based on the classified attack type.

A method for the exploit attack type classification apparatus 10 to perform attack type classification will be clarified later through description of the specification.

Hereinafter, for convenience of description, the attack detection system 20a or 20b will be abbreviated as the detection system 20a or 20b. Further, based on referring to a plurality of detection systems 20a and 20b, or based on referring to any attack system 20a or 20b, reference numeral “20” may be used. Likewise, based on referring to a plurality of domains 30a and 30b, or referring to any domain 30a or 30b, the reference number “30” may be used.

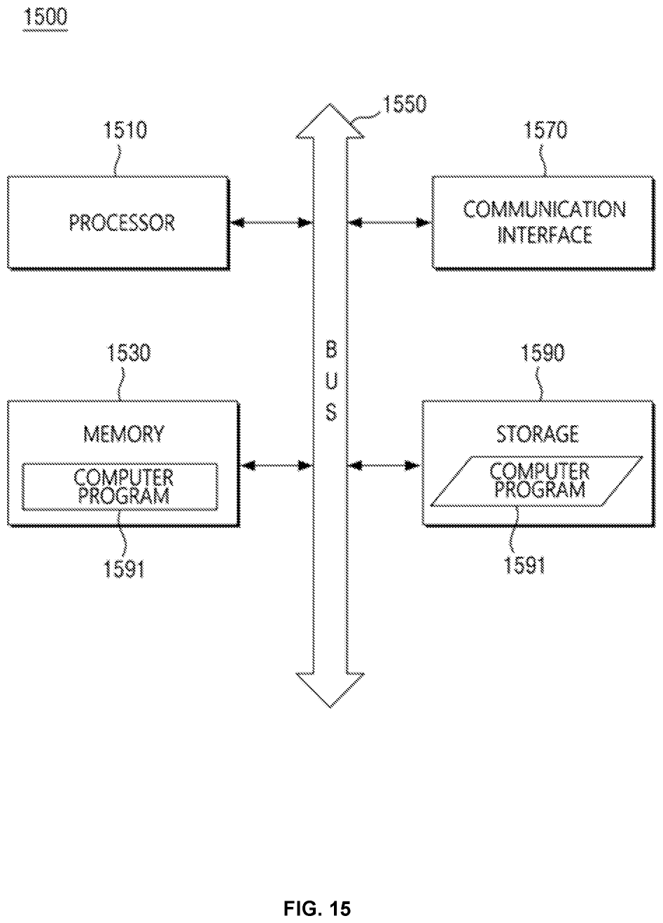

The exploit attack type classification apparatus 10 or the detection system 20 may be implemented with one or more computing devices. For example, all functions of the exploit attack type classification apparatus 10 may be implemented in a single computing device. As another example, the first function of the exploit attack type classification apparatus 10 may be implemented in the first computing device, and the second function may be implemented in the second computing device. Here, the computing device may be a notebook, a desktop, a laptop, etc., but may not be limited thereto and may include all types of devices equipped with a computing function. However, based on it being an environment, in which the exploit attack type classification apparatus 10 may be used to provide the detection system 20 with rulesets 32 and 33 that detect exploit attacks in conjunction with various domains 30, the exploit attack type classification apparatus 10 may be implemented as a high-performance server-class computing device. An example of the above-described computing device will be described later with reference to FIG. 15.

The domain 30 may be an area divided or defined according to a logical or physical criterion, and the domain 30 may include one or more devices (e.g., 22 to 26) and a detection system 20. For example, the first domain 30a may include one or more devices 22 to 26 and a detection system 20a that detects an exploit attack on the devices 22 to 26.

The domain 30 may be defined by an administrator, and may be automatically determined based on the number or type of devices (e.g., 22 to 26). For example, a certain number of devices (e.g., 22 to 26) may be included in the domain 30, and a new domain may be dynamically formed based on the number of devices exceeding a reference value. A plurality of sub-domains may exist in the domain 30.

The detection system 20 may detect an exploit attack on devices (e.g., 22 to 26) belonging to the domain 30 based on the detection rule. For example, the first detection system 20a may detect an exploit attack on the devices 22 to 26 belonging to the first domain 30a using the first ruleset 32. Further, the second detection system 20b may detect an exploit attack on a device belonging to the second domain 30b by using the second ruleset 33.

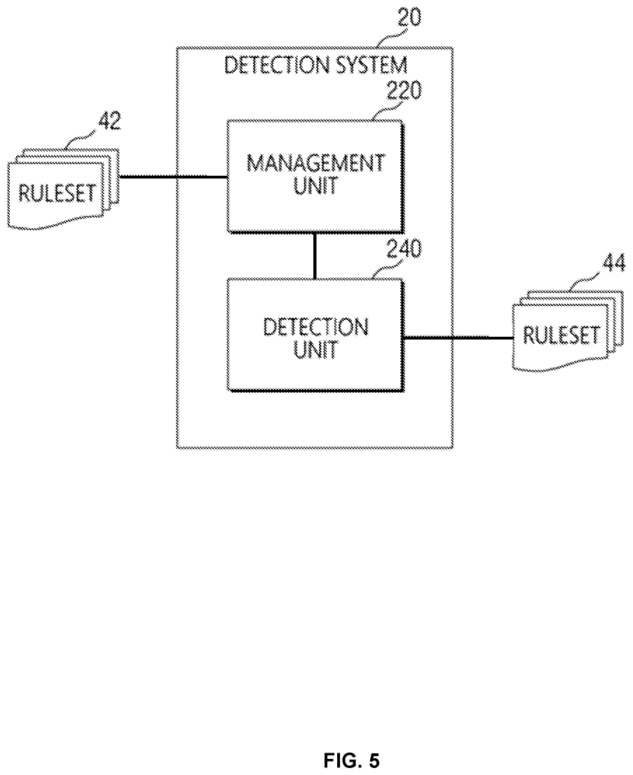

Further, the detection system 20 may log an attack detection result and provide log data (e.g., 34) including this to the exploit attack type classification apparatus 10. The provided log data (e.g., 34) may be used for optimization of detection rules. The detailed configuration and operation of the detection system 20 will be described later with reference to FIG. 5.

In some embodiments, the exploit attack type classification apparatus 10 and the detection system 20 may communicate over a network. The network can be implemented with all types of wired/wireless networks such as a local area network (LAN), a wide area network (WAN), a mobile radio communication network, and a wireless broadband Internet (Wibro).

Meanwhile, FIG. 1 shows an embodiment for achieving the object of the present disclosure, and some components may be added or deleted. Further, it should be noted that the components of the exemplary environment illustrated in FIG. 1 represent functional elements that may be functionally divided, and a plurality of components may be implemented in a form integrated with each other in an actual physical environment. For example, the exploit attack type classification apparatus 10 and the detection system 20 may be implemented in different types of logic within the same computing device.

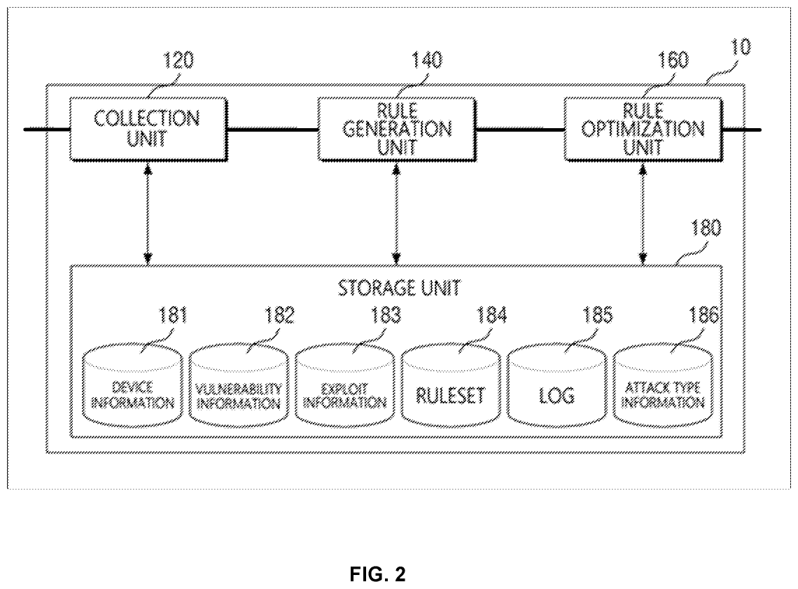

So far, an exemplary environment, in which the exploit attack type classification apparatus 10 according to an embodiment of the present disclosure can be applied, has been described with reference to FIG. 1. Hereinafter, the configuration and operation of the exploit attack type classification apparatus 10 and the detection system 20 will be described with reference to FIGS. 2 to 5.

FIG. 2 is an exemplary block diagram illustrating an exploit attack type classification apparatus 10 according to an embodiment of the present disclosure.

As shown in FIG. 2, the exploit attack type classification apparatus 10 may include a collection unit 120, a rule generation unit 140, a rule optimization unit 160, and a storage unit 180. However, components related to various embodiments of the present disclosure may be shown in FIG. 2. Those skilled in the art, to which the present disclosure belongs, may recognize that other general-purpose components may be further included in addition to the components shown in FIG. 2. Further, it should be noted that each component of the exploit attack type classification apparatus 10 shown in FIG. 2 represents functional elements that may be functionally divided, and a plurality of components may be implemented in a form, in which they may be integrated with each other in an actual physical environment. Hereinafter, each component will be described.

The collection unit 120 may collects various types of information for classifying exploit attack types, generating detection rules, and optimizing detection rules. For example, the collection unit 120 may collect device information (e.g., name, manufacturer, operating system, firmware, etc.), device vulnerability information (e.g., CVE information), exploit information, and the like.

The method of collecting information by the collection unit 120 may be any method. For example, the collection unit 120 may automatically collect information through web crawling. As another example, the collection unit 120 may manually receive information from a file or an input device.

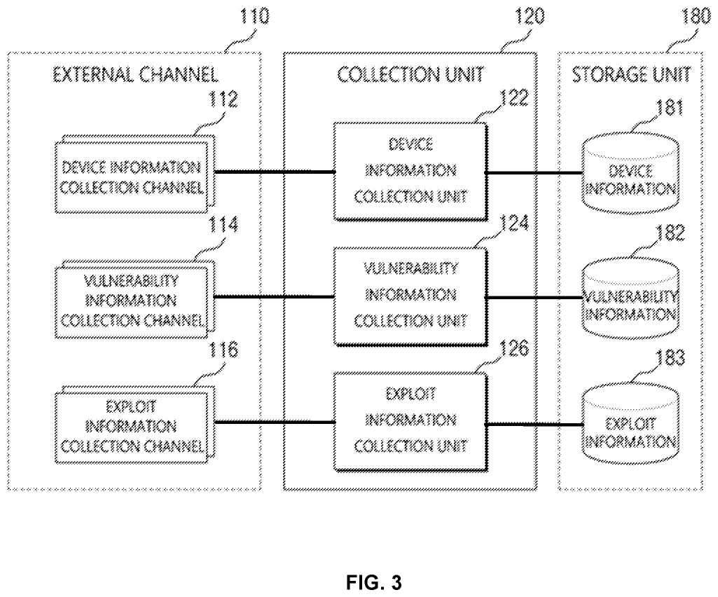

In some embodiments, as shown in FIG. 3, the collection unit 120 may include a device information collection unit 122, a vulnerability information collection unit 124, and an exploit information collection unit 126. Each of the information collection units 122 to 126 may collect device information, vulnerability information, and exploit information from the external channel 110. The collected information may be stored and managed through the storage unit 180. Hereinafter, the operation of each of the collection units 122 to 126 will be briefly described.

The device information collection unit 122 may collect device information through one or more device information collection channels 112. The collected device information may be stored in the device information storage 181 through the storage unit 180. The device information collection channel 112 may be, for example, a website of a device manufacturer, but the scope of the present disclosure may not be limited thereto. The device information may include all information about the device, such as a device name, manufacturer, operating system type, operating system version, firmware type, and firmware version.

Next, the vulnerability information collection unit 124 may collect vulnerability information through one or more vulnerability information collection channels 114. The collected vulnerability information may be stored in the vulnerability information storage 182 through the storage unit 180. The vulnerability information collection channel 114 may be, for example, a website for posting vulnerability information such as a National Vulnerabilities Database (NVD) or VulDB, or a website of a device manufacturer, on which the vulnerability information may be posted, but the scope of the present disclosure may not be limited thereto. The vulnerability information may include, for example, Common Vulnerability and Exposures (CVE) information. CVE information may include Common Vulnerabilities and Exposures IDentifier (CVE-ID), Vulnerability Overview, Common Vulnerability Scoring System (CVSS), Common Platform Enumeration (CPE), and Common Weakness Enumeration (CWE), etc., but this may be obvious to those skilled in the art, so a description of the CVE information itself will be omitted. Further, the vulnerability information may include, for example, Common Weakness Enumeration (CWE) information. CWE information may be information about security weaknesses and includes information about errors that can lead to vulnerabilities. CWE information may categorize defect types into view, category, security weakness, and compound element, and each type may be given a name and an identifier (ID). Since CWE information may be obvious to those skilled in the art, the description of CWE information itself will be omitted.

Next, the exploit information collection unit 126 may collect exploit information through one or more exploit collection channels 114. The collected exploit information may be stored in the exploit information storage 183 through the storage unit 180. The exploit collection channel 114 may be, for example, an EDB (Exploit DataBase) website, but the scope of the present disclosure may not be limited thereto. The exploit information may include, for example, an exploit code, an exploit attack type, and related vulnerability information.

It will be described again with reference to FIG. 2.

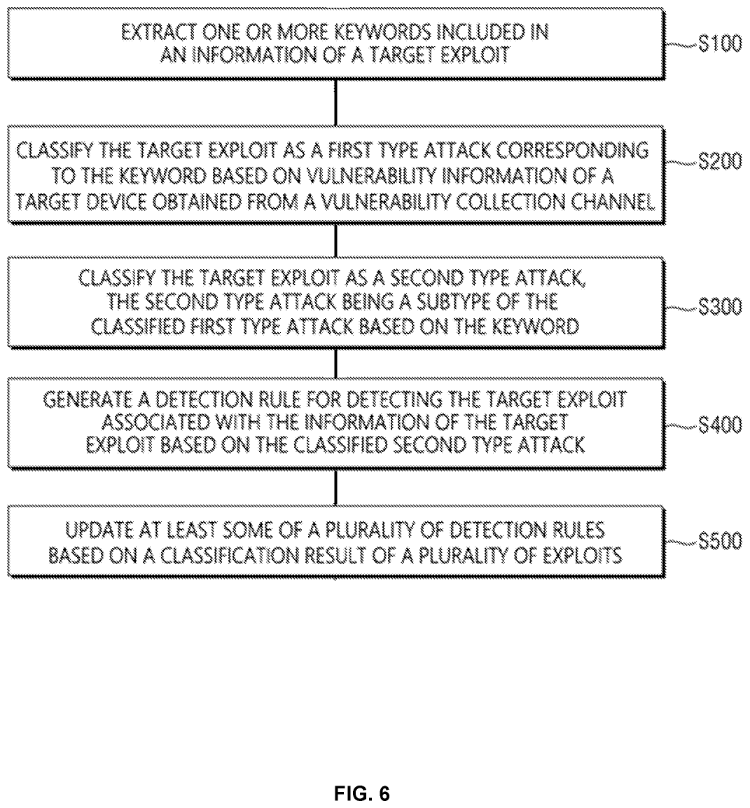

The rule generation unit 140 may generate a detection rule for detecting an exploit attack based on the collected information. For example, the rule generation unit 140 may analyze the exploit code to classify the type of the exploit attack, or extract a signature or detection pattern for detecting the exploit attack. Further, the rule generation unit 140 may generate a detection rule based on the classified attack type and analysis result (e.g., signature, detection pattern, etc.). In order to exclude redundant descriptions, a more detailed description of the operation of the rule generation unit 140 will be described later with reference to FIGS. 6 to 14.

Next, the rule optimization unit 160 may optimize the detection rule based on log data including an attack detection result or information on devices belonging to the domain 30. Further, the rule optimization unit 160 may optimize the detection rule based on the attack type classification result.

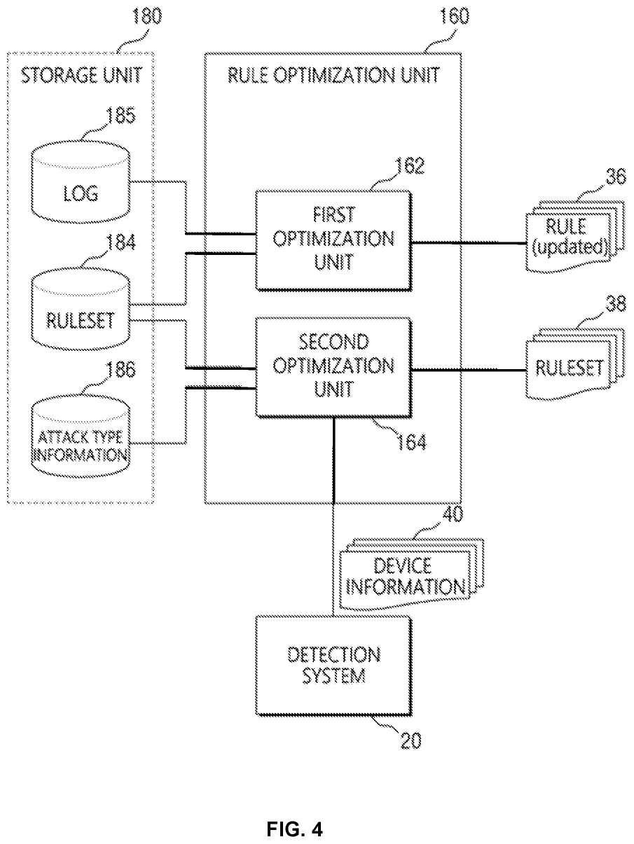

In some embodiments, as shown in FIG. 4, the rule optimization unit 160 may include a first optimization unit 162 and a second optimization unit 164. Hereinafter, the operation of each of the rule optimization units 162 and 164 will be briefly described.

The first optimization unit 162 may analyze log data including the attack detection result and update the rules stored in the ruleset storage 184. The updated rule 36 may be stored again in the ruleset storage 184 through the storage unit 180. The log data may be obtained from the log storage 185. The optimization operation (i.e., log data analysis and rule update operation) of the first optimization unit 162 may be performed periodically or performed repeatedly based on a condition being satisfied (e.g., based on the detection rate of a domain being less than the reference value, based on the detection rate of a domain being a decreasing trend, etc.). By doing so, the detection rules can be gradually optimized.

Next, the second optimization unit 164 may optimize a ruleset applied to the target domain based on the information 40 of the device belonging to the target domain. Here, the target domain may be understood as referring to any domain to be optimized. The device information 40 may be provided from the detection system 20 of the target domain. The optimized ruleset 38 may be delivered to the target domain and can be applied to the detection system 20 of the target domain. The optimization operation (i.e., device information acquisition and ruleset update operation) of the second optimization unit 164 may be performed periodically or performed repeatedly based on a condition being satisfied (e.g., based on the detection rate of the target domain being less than the reference value, the trend of fluctuations in the detection rate of the target domain may be a decreasing trend, based on a new device being added to the target domain, etc.). By doing so, the ruleset of the target domain can be gradually optimized.

Further, the second optimization unit 164 may optimize a ruleset applied to the target domain based on classified attack type information corresponding to the vulnerability of the device information 40 belonging to the target domain. The device information 40 may be provided from the detection system 20 of the target domain. The optimized ruleset 38 may be delivered to the target domain and can be applied to the detection system 20 of the target domain. The optimization operation (i.e., device information acquisition and ruleset update operation) of the second optimization unit 164 may be performed periodically or performed repeatedly based on a condition being satisfied (e.g., attack type classification result, reflecting the increasing or decreasing trend of the number of each classified attack type, etc.). By doing so, the ruleset of the target domain can be gradually optimized.

As described through the second optimization unit 164, a ruleset optimized according to the characteristics of the target domain (e.g. the number, type, etc. of belonging devices) may be provided to the target domain and used for attack detection. That is, by providing a ruleset specialized in the target domain, it may be possible to accurately and quickly detect an attack with a lightweight ruleset.

It will be described again with reference to FIG. 2.

The storage unit 180 may manage (e.g., storage, inquiry, modification, deletion, etc.) various types of information used in the exploit attack type classification apparatus 10. Various types of information may include, for example, device information, vulnerability information, exploit information, ruleset information, log data, and attack type information (e.g., attack type classification information of an exploit code), but may not be limited thereto. Various types of information may be stored in the storages 181 to 186 managed by the storage unit 180. For efficient information management, the storages 181 to 186 may be implemented by a storage medium converted into DB.

Further, the storage unit 180 may provide information stored in each of the storages 181 to 186 to other modules 120 to 160, or store information received from the other modules 120 to 160 in the corresponding storages 181 to 186.

Hereinafter, a detection system 20 that can be referred to in some embodiments of the present disclosure will be described with reference to FIG. 5.

As shown in FIG. 5, the detection system 20 may include a management unit 22 and a detection unit 240. However, the components related to the embodiment of the present disclosure may be shown in FIG. 5. Those skilled in the art, to which the present disclosure belongs, may recognize that other general-purpose components may be further included in addition to the components shown in FIG. 5. Hereinafter, each component will be described.

The management unit 220 may set, control, monitor, or manage all functions and operations of the detection system 20. For example, the management unit 220 may receive the ruleset 42 from the exploit attack type classification apparatus 10 and set the ruleset 42 as the detection rule of the corresponding domain. In addition, the management unit 220 may monitor or control the operation of the detection unit 240 in real time. The management unit 220 may be implemented as a management tool used by an administrator, but the technical scope of the present disclosure may not be limited thereto.

Next, the detection unit 240 may detect an exploit attack based on the ruleset 42 set by the management unit 220. The detection unit 240 may be a type of detection engine, and may monitor the operation of devices belonging to the domain or network traffic, and take appropriate actions (e.g., allow, block, etc.) on the operation of the device or network traffic based on the ruleset 42. For example, based on an exploit attack being detected in a device operation or network traffic, the detection unit 240 may block the device operation or network traffic.

Further, the detection unit 240 may log all detection operations performed based on the ruleset 42 in the log data 44. For example, the detection unit 240 may log an applied ruleset and the detection result according to the applied ruleset in the log data 44. As described above, the log data 44 may be delivered to the exploit attack type classification apparatus 10 and used in the rule optimization.

Meanwhile, each component illustrated in FIGS. 2 to 5 may refer to software or hardware such as a Field Programmable Gate Array (FPGA) or an Application-Specific Integrated Circuit (ASIC). However, the components may not be limited to software or hardware, and may be configured to be in an addressable storage medium, or may be configured to execute one or more processors. Functions provided within the components may be implemented by more subdivided components, or may be implemented as one component that performs a function by combining a plurality of components.

So far, the configuration and operation of the exploit attack type classification apparatus 10 and detection system 20 according to an embodiment of the present disclosure have been described with reference to FIGS. 2 to 5. Hereinafter, methods according to various embodiments of the present disclosure will be described in detail.

Each step of the methods may be performed by a computing device. In other words, each step of the methods may be implemented with one or more instructions executed by the processor of the computing device. All steps included in the methods may be performed by one physical computing device, but the first steps of the method may be performed by a first computing device, and the second steps of the method may be performed by a second computing device. Hereinafter, description will be continued on the assumption that each step of the methods may be performed by the exploit attack type classification apparatus 10 illustrated in FIG. 1. However, for convenience of description, the description of the operation subject of each step included in the methods may be omitted.

FIG. 6 is an exemplary flow chart showing a method of classifying an exploit attack type according to another embodiment of the present disclosure. However, this may be an embodiment for achieving the object of the present disclosure, and some steps may be added or deleted.

Referring to FIG. 6, in step S100, one or more keywords included in exploit information may be extracted. Here, the keyword may be a criterion for classifying the type of exploit information (e.g., exploit code).

The step of collecting exploit information may precede in order to extract the keyword in this step. In this case, in addition to the exploit information, various information such as device information and vulnerability information may be collected. Further, various types of information may be collected in association with each other.

A detailed description of the steps, in which the above-described various types of information may be collected, will be described. For example, by searching a vulnerability information channel and an exploit information channel using the collected device information (e.g., device information of a target domain), vulnerability information and exploit information corresponding to a device may be collected. Through such a collection method, vulnerability information and exploit information corresponding to the device can be efficiently collected. For another example, the information on the first vulnerability may be stored in association with information on the first exploit attack that exploited the first vulnerability, and the information on the second vulnerability may be stored in association with information on the second exploit attack that exploited the second vulnerability.

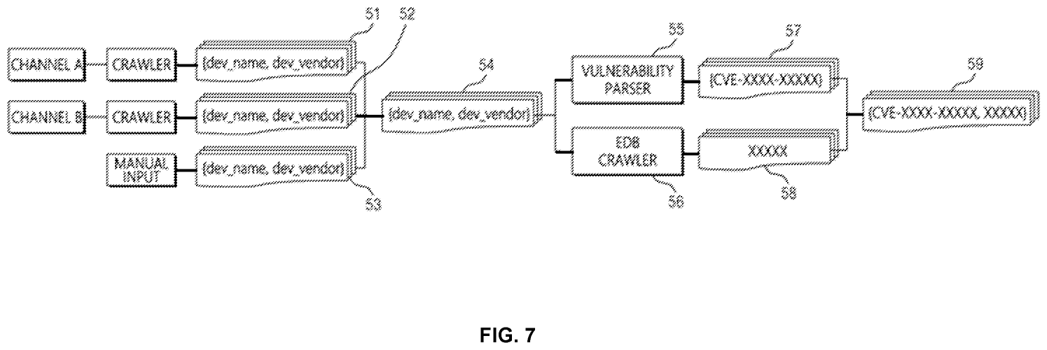

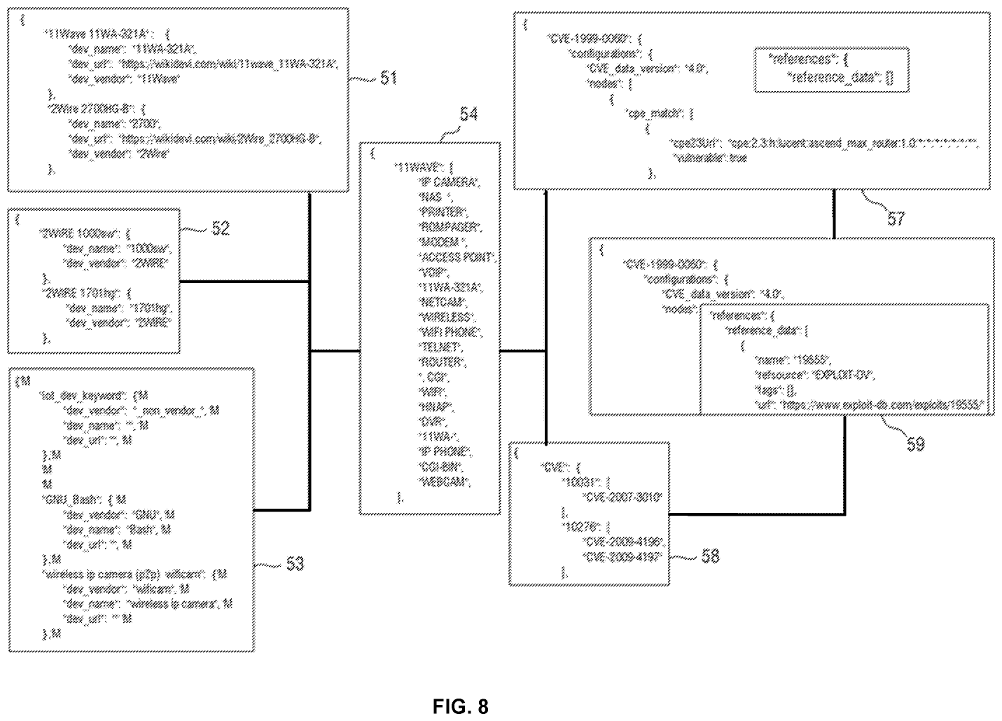

In order to provide a more convenient understanding, an example of a step of collecting various types of information will be briefly described with reference to FIGS. 7 and 8.

As illustrated in FIG. 7, device information 51 and 52 may be collected from one or more channels A and B through a crawler. And, device information 53 known to the administrator may be collected through manual input. The collected device information 51 to 53 may be integrated.

Further, the vulnerability parser 54 may collect and extract the vulnerability information 57 by using the integrated device information 54. For example, the vulnerability parser 54 may collect CVE information and extract vulnerability information 57 associated with the device information 54 from the collected information.

Further, the EDB crawler 56 may collect the exploit information 58 associated with the device information 54 from the EDB website. The exploit information 58 may be linked with the vulnerability information 57 to form the linkage information 59, and the linkage information 59 may be stored in a storage.

Referring to FIG. 8, it can be seen that an example of the collecting step of various types of information of FIG. 7 described above is illustrated. It should be noted that FIG. 8 illustrates an example in the collecting step of various types of information that can be referred to in some embodiments of the present disclosure, and does not limit the scope of the present disclosure.

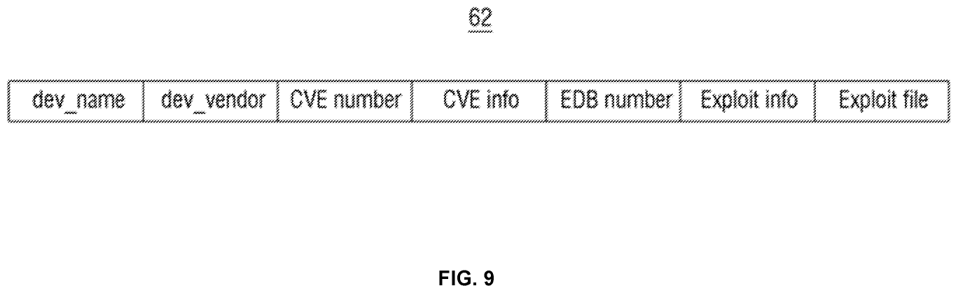

FIG. 9 illustrates the types of collection information 62 that can be referred to in various embodiments of the present disclosure. As illustrated in FIG. 9, the information 62 collected in the above-described manner includes device information including a device name (dev_name) and a manufacturer (dev_vendor), vulnerability information including a CVE identifier (CVE_number) and CVE detailed information (CVE info), and exploit information including EDB reference number (or identifier; EDB number), basic information of the exploit (Exploit info), and code of the exploit (exploit file). At this time, it should be noted that the vulnerability information may additionally include a CWE identifier (CWE_number) and detailed information (CWE info), or replace the above-described CVE identifier (CVE_number) and CVE detailed information (CVE info) with a CWE identifier (CWE_number) and detailed information (CWE info).

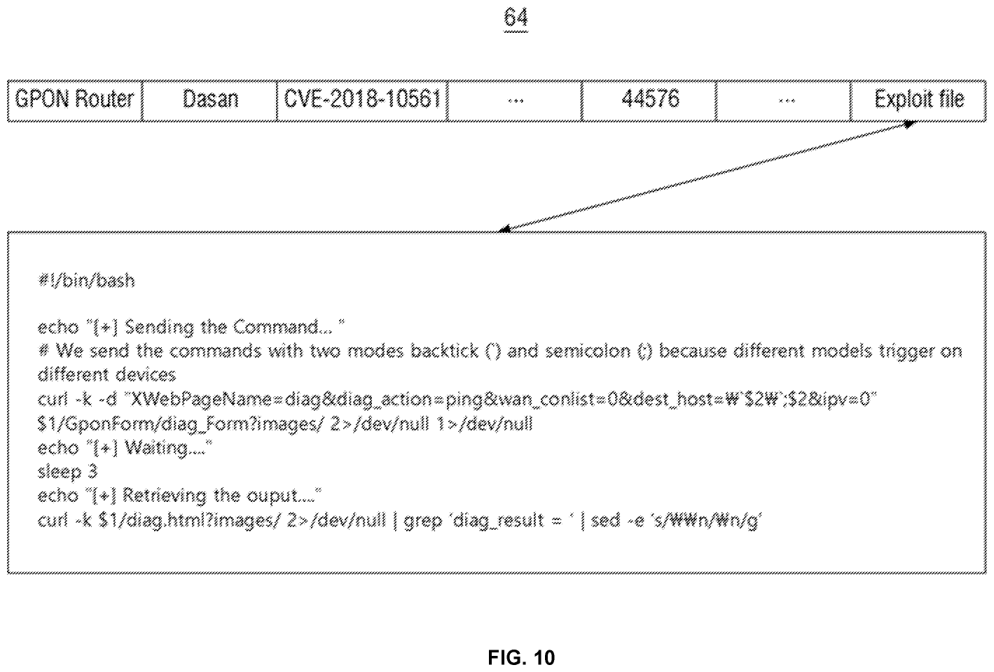

FIG. 10 shows an example of collection information 64 that may be referred to in various embodiments of the present disclosure. For example, FIG. 10 illustrates a case where the device may be a GPON router manufactured by Dasan, and the identifier of CVE information associated with the GPON router may be “CVE-2018-35061,” and illustrates together the actual code of the exploit attack associated with CVE information (“CVE-2018-35061”).

It will be described again with reference to FIG. 6.

In some embodiments related to step S100, the step of extracting the keyword may extract the keyword based on payload information included in the exploit code. Here, the payload may be a part of data that may be the fundamental purpose of the exploit code and refers to data excluding data such as a header included in the code. That is, by referring to the payload of the exploit code, a criterion for classifying the attack type of the exploit code can be prepared.

Next, in step S200, a first attack type corresponding to the extracted keyword may be classified based on the vulnerability information obtained from the vulnerability collection channel.

In some embodiments related to step S200, information collected and stored in association with various types of information described above may be efficiently used. For example, the first attack type may be determined based on vulnerability information collected and stored in association with the exploit information. For another example, based on the device information collected and stored in association with the exploit information, one or more vulnerability information corresponding to one or more vulnerabilities of the device may be determined, and the first attack type may be determined based on vulnerability information matching the extracted keyword among the one or more vulnerability information. That is, as described above, by linking and collecting various types of information, it may be possible to easily search for vulnerability information matching a keyword.

In some other embodiments related to step S200, even in a situation in which the above-described various information may not be linked and collected, vulnerability information matching a keyword among a plurality of vulnerability information collected from the vulnerability collection channel may be determined, and the first attack type may be determined based on the determined vulnerability information.

Next, in step S300, a second attack type, which may be a subtype of the classified first attack type, may be classified based on the keyword. Here, the first attack type may be a large classification of attack types determined based on the above-described vulnerability information, and the second attack type may be a subtype of the first attack type, and may be a small classification of attack types determined by keywords.

Further, as described above with respect to the keyword, it should be noted that the keyword may be extracted based on the payload of the exploit code, and the second attack type may be classified based on the payload of the exploit code.

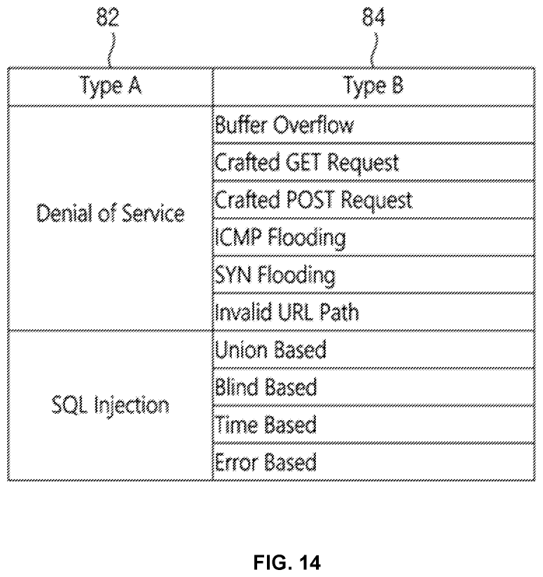

Examples of the first attack type and the second attack type described in steps S200 and S300 can be seen with reference to FIG. 14. For example, FIG. 14 illustrates an example, in which the first attack type 82 may be a Denial of Service (DoS) attack, and the second attack type 84, which may be a subtype of the first attack type, may be a Buffer Overflow attack, Crafted GET Request attack, Crafted POST Request attack, ICMP Flooding attack, SYN Flooding attack, and Invalid URL Path attack. Further, FIG. 14 illustrates an example, in which the first attack type 82 may be a SQL injection attack, and the second attack type 84, which may be a subtype of the first attack type, may be a Union-based SQL injection attack, Blind-based SQL injection attack, Time-based SQL Injection attack and Error-based SQL Injection attack. That is, referring to FIG. 14, it can be understood that exploit attack types can be classified according to a hierarchical classification criterion (e.g., a first attack type may be an upper type of a second attack type) according to some embodiments of the present disclosure. A detailed description of the individual attacks shown in FIG. 14 will be omitted.

In some embodiments related to steps S200 and S300, based on the classification of the exploit attack type by step S200 being unsuccessful, the administrator may manually classify the exploit attack type. Further, in some other embodiments related to steps S200 and S300, based on the first attack type classification by step S200 being successful, but the second attack type classification by step S300 fails, the administrator may manually classify the exploit attack type as well.

Next, in step S400, a detection rule for detecting an attack associated with the exploit information may be generated based on the classified attack type. In this case, a detection rule may be generated using the analysis result of the exploit code (e.g., signature or pattern) and the classified attack type.

For example, a detection rule may be generated by using a signature extracted through code analysis as a rule detection condition and defining an action of the rule according to the risk of an attack derived through attack type information. However, a method of generating a detection rule may not be limited thereto, and one or more rule generation algorithms well known in the art may be used.

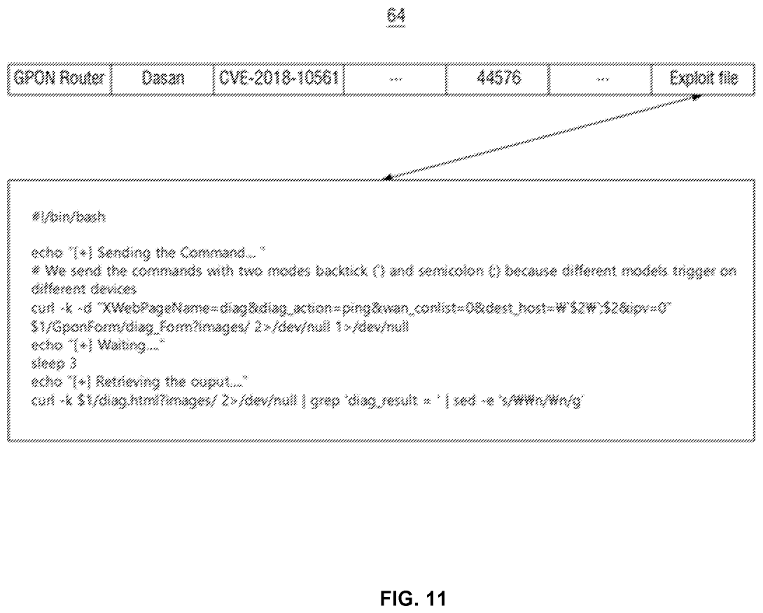

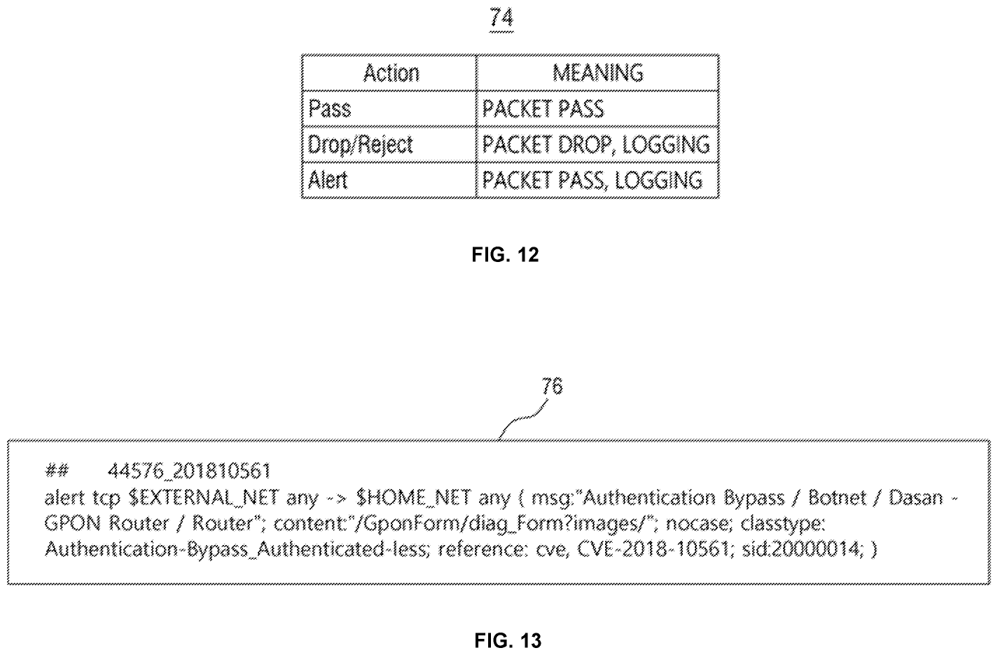

FIGS. 11 to 12 illustrate a rule format 72 and a definition of an action field 74 that can be referred to in various embodiments of the present disclosure, and they may be defined based on the rule format used in the attack detection system such as snort or suricata. In the rule format 72 illustrated in FIG. 11, “action” of a rule header means an action performed based on a rule condition being satisfied, and at least some fields of a rule header or a rule option may constitute a rule condition. Those skilled in the art may already be familiar with the rule format of the attack detection system, and a detailed description thereof will be omitted.

FIG. 12 illustrates a case, in which three actions may be set in the action field, but the number and type of actions may vary.

FIG. 13 shows an example of a detection rule 76 generated by analyzing the exploit code illustrated in FIG. 10 and classifying an attack type. For example, FIG. 13 exemplifies an actual rule for detecting an exploit attack that exploits the vulnerability of Dasan's GPON router (“CVE-2018-35061”). Those skilled in the art can clearly understand the detection rule, and a detailed description thereof will be omitted.

Again, the description will be continued with reference to FIG. 6.

Next, in step S500, at least some of the plurality of detection rules may be updated based on the classification result of the plurality of exploit information. For example, as a result of classifying a plurality of exploit information, an increasing or decreasing trend of the number of each second attack type item may be calculated. This calculation may be performed for each device or for each domain, or for all devices or for all domains.

In some embodiments related to step S500, the detection rule may be updated based on an increasing or decreasing trend of the number of each second attack type item calculated as a result of attack type classification. Here, the increasing or decreasing trend of the number of each second attack type item may reflect the trend at the time of calculation. That is, the exploit attack type that may be prevalent at the time of calculation can be derived.

Hereinafter, one example, in which the detection rule may be updated, will be described.

For example, the response strength to the second attack type, in which the calculated trend may be an increasing trend, may be raised. As one example, based on the trend being an increasing trend, the action level of the rule may be raised (e.g., alert−>drop). This may be because the second attack type, in which the number of classified exploit information may be increasing, is an attack method that is currently prevalent, and may be likely to be an attack with high risk. Further, an upward degree of the action level may be determined based on a slope of an increasing trend. For example, based on the slope being greater than or equal to the reference value (e.g., based on the number increasing rapidly), the action level of the rule may be raised by one or more steps. In the opposite case (i.e., in the case of a decreasing trend), the action level of the rule may be lowered (e.g. drop->alert).

As another example, the application priority of a rule, in which the calculated trend may be an increasing trend, may be raised. In this case, the upward degree of the priority may be determined based on the slope of the increasing trend. For example, based on the slope being greater than or equal to the reference value (e.g., based on the number increasing rapidly), the application priority of the rule may be raised furthermore. In the opposite case (i.e., in the case of a decreasing trend), the application priority of the rule may be lowered. According to this example, a detection rule corresponding to a second attack type, in which the number of classified exploit information may be increasing, may be first applied, thereby improving the detection speed for a recently prevalent exploit attack.

As another example, a detection rule, in which the calculated trend may be a decreasing trend, may be deleted or designated as a modification target. The rule designated as a modification target may be provided to the administrator so that the detection rule can be reviewed. According to this example, the detection rule corresponding to the second attack type, in which the number of classified exploit information may be decreasing, may be deleted, thereby reducing the weight of the ruleset applied to the attack detection system.

For reference, the step of collecting various information may be performed by the collection unit 120, steps S100 to S400 may be performed by the rule generation unit 140, and step S500 may be performed by the rule optimization unit 160.

So far, a method of classifying an exploit attack type according to an embodiment of the present disclosure has been described with reference to FIGS. 6 to 14. According to the above-described method, attack types of exploit information can be classified. And, based on the classification result of the attack type, a detection rule for detecting an attack related to the exploit information may be generated. Further, the detection rule may be optimized based on the classification result of an attack type of a plurality of exploit information. Since such a series of processes may be performed in an automated manner, human and time costs for domain security can be greatly reduced. In addition, since the detection rule generation and update process may be continuously performed, even based on a new exploit attack appearing, the rule can be updated immediately.

Hereinafter, an exemplary computing device 1500 that can implement an apparatus and a system, according to various embodiments of the present disclosure will be described with reference to FIG. 15.

FIG. 15 is an example hardware diagram illustrating a computing device 1500.

As shown in FIG. 15, the computing device 1500 may include one or more processors 1510, a bus 1550, a communication interface 1570, a memory 1530, which loads a computer program 1591 executed by the processors 1510, and a storage 1590 for storing the computer program 1591. However, FIG. 15 illustrates the components related to the embodiment of the present disclosure. It will be appreciated by those skilled in the art that the present disclosure may further include other general purpose components in addition to the components shown in FIG. 15.

The processor 1510 controls overall operations of each component of the computing device 1500. The processor 1510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 1510 may perform calculations on at least one application or program for executing a method/operation according to various embodiments of the present disclosure. The computing device 1500 may have one or more processors.

The memory 1530 may store various data, instructions and/or information. The memory 1530 may load one or more programs 1591 from the storage 1590 to execute methods/operations according to various embodiments of the present disclosure. For example, based on the computer program 1591 being loaded into the memory 1530, the logic as shown in FIG. 6 may be implemented on the memory 1530. An example of the memory 1530 may be a RAM, but may not be limited thereto.

The bus 1550 provides communication between components of the computing device 1500. The bus 1550 may be implemented as various types of bus such as an address bus, a data bus and a control bus.

The communication interface 1570 may support wired and wireless internet communication of the computing device 1500. The communication interface 1570 may support various communication methods other than internet communication. To this end, the communication interface 1570 may be configured to comprise a communication module based on hardware and/or software well known in the art of the present disclosure.

The storage 1590 can non-temporarily store one or more computer programs 1591. The storage 1590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 1591 may include one or more instructions, on which the methods/operations according to various embodiments of the present disclosure may be implemented. Based on the computer program 1591 being loaded on the memory 1530, the processor 1510 may perform the methods/operations in accordance with various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations may be shown in an order in the drawings, those skilled in the art will appreciate that many variations and modifications can be made to the embodiments without substantially departing from the principles of the present disclosure. The disclosed embodiments of the present disclosure may be used in a generic and descriptive sense and not for purposes of limitation. The scope of protection of the present disclosure should be interpreted by the following claims, and all technical ideas within the scope equivalent thereto should be construed as being included in the scope of the technical idea defined by the present disclosure.

What is claimed is:

1. A method performed by a computing device for classifying a type of exploit comprising:
extracting one or more keywords included in first information of a target exploit;
classifying the target exploit as a first type attack corresponding to one of the one or more keywords based on vulnerability information of a target device obtained from a vulnerability collection channel;
classifying the target exploit as a second type attack, the second type attack being a subtype of the classified first type attack based on the one of the one or more keywords; and
generating a detection rule for detecting the target exploit associated with the first information of the target exploit based on the classified second type attack.

2. The method of claim 1,
wherein the first information of the target exploit comprises
an exploit code,
wherein extracting the one of the one or more keywords comprises
extracting the one of the one or more keywords based on a payload portion within the exploit code.

3. The method of claim 1,
wherein the first information of the target exploit includes second information collected through web crawling from one or more exploit collection channels,
wherein the vulnerability information is cross-related with the first information of the target exploit and includes third information collected through web crawling from one or more vulnerability collection channels.

4. The method of claim 1,
wherein the first information of the target exploit is fourth information of exploit for the target device included in a target domain among a plurality of domains connected to a network.

5. The method of claim 1 further comprises
updating at least some of a plurality of detection rules based on a classification result of a plurality of exploits.

6. The method of claim 5,
wherein the updating comprises
calculating an increasing or decreasing trend of the number of the classified second type attack; and
raising a strength of a response to the second type attack whose number has an increasing trend based on the calculation.

7. The method of claim 5,
wherein the updating comprises
calculating an increasing or decreasing trend of the number of the classified second type attack; and
raising a priority of a detection rule corresponding to the second type attack whose number has an increasing trend based on the calculation.

8. The method of claim 5,
wherein the updating comprises
calculating an increasing or decreasing trend of the number of the classified second type attack; and
lowering a strength of a response to the second type attack whose number has a decreasing trend based on the calculation.

9. The method of claim 5,
wherein the updating comprises
calculating an increasing or decreasing trend of the number of the classified second type attack; and
deleting a detection rule corresponding to the second type attack whose number has a decreasing trend based on the calculation, or designating the detection rule as a modification target.

10. The method of claim 1,
wherein the first type attack includes a Denial of Service (DoS) attack,
wherein the second type attack includes one or more of a Buffer Overflow attack, Crafted GET Request attack, Crafted POST Request attack, ICMP Flooding attack, SYN Flooding attack and Invalid URL Path attack.

11. The method of claim 1,
wherein the first type attack includes a SQL injection attack,
wherein the second type attack includes one or more of a Union-based SQL Injection attack, Blind-based SQL Injection attack, Time-based SQL Injection attack, and Error-based SQL Injection attack.

12. An apparatus for classifying a type of exploit comprising:
a processor;
a network interface;
a memory; and
a computer program loaded into the memory and executed by the processor,
wherein the computer program comprises
a first instruction for extracting one or more keywords included in first information of a target exploit;
a second instruction for classifying the target exploit as a first type attack corresponding to one of the one or more keywords based on vulnerability information of a target device obtained from a vulnerability collection channel;
a third instruction for classifying the target exploit as a second type attack, the second type attack being a subtype of the classified first type attack based on the one of the one or more keywords ; and
a fourth instruction for generating a detection rule for detecting the target exploit associated with the first information of the target exploit based on the classified second type attack.

13. The apparatus of claim 12,
wherein the first information of the target exploit comprises
an exploit code,
wherein extracting the one of the one or more keywords comprises
extracting the one of the one or more keywords based on a payload portion within the exploit code.

14. The apparatus of claim 12,
wherein the first information of the target exploit includes second information collected through web crawling from one or more exploit collection channels,
wherein the vulnerability information is cross-related with the first information of the target exploit and includes third information collected through web crawling from one or more vulnerability collection channels.

15. The apparatus of claim 12,
wherein the first information of the target exploit is fourth information of exploit for the target device included in a target domain among a plurality of domains connected to a network.

16. The apparatus of claim 12 further comprises
a fifth instruction for updating at least some of a plurality of detection rules based on a classification result of a plurality of exploits.

17. The apparatus of claim 16,
wherein the updating comprises
a sixth instruction for calculating an increasing or decreasing trend of the number of the classified second type attack; and
a seventh instruction for raising a strength of a response to the second type attack whose number has an increasing trend based on the calculation.

18. The apparatus of claim 12,
wherein the first type attack includes a Denial of Service (DoS) attack,
wherein the second type attack includes one or more of a Buffer Overflow attack, Crafted GET Request attack, Crafted POST Request attack, ICMP Flooding attack, SYN Flooding attack and Invalid URL Path attack.

19. The apparatus of claim 12,
wherein the first type attack includes a SQL injection attack,
wherein the second type attack includes one or more of a Union-based SQL Injection attack, Blind-based SQL Injection attack, Time-based SQL Injection attack, and Error-based SQL Injection attack.

20. A computer-readable recording medium recording a computer program including computer program instructions executable by a processor for classifying a type of exploit,
wherein the computer program instructions are executed by a processor of a computing device for performing operations comprising,
extracting one or more keywords included in first information of a target exploit;
classifying the target exploit as a first type attack corresponding to one of the one or more keywords based on vulnerability information of a target device obtained from a vulnerability collection channel;
classifying the target exploit as a second type attack, the second type attack being a subtype of the classified first type attack based on the one of the one or more keywords ; and
generating a detection rule for detecting the target exploit associated with the first information of the target exploit based on the classified second type attack.
